(19) United States
(12) Patent Application Publication
(10) Pub. No.: US 2026/0334553 A1
(43) Pub. Date: Oct. 29, 2026

(54) AEROSOL GENERATING APPARATUS

(71) Applicant: Imperial Tobacco Limited, Bristol (GB)

(72) Inventors: Lik Hon, Amsterdam (NL); Zhuoran Li, Beijing (CN); Fucheng Yu, Beijing (CN); David Thomas, Bristol (GB); Robert Wallace, Bristol (GB); Phillip Taylor, Bristol (GB); Jan Hyla, Bristol (GB)

(21) Appl. No.: 19/487,393

(22) PCT Filed: May 26, 2023
(86) PCT No.: PCT/CN2023/096460

§ 371 Date: Nov. 24, 2025

(51) Int. Cl. A24F 40/46; A24F 40/10; A24F 40/57

(52) U.S. Cl. CPC A24F 40/46; A24F 40/57; A24F 40/10

(57) ABSTRACT

The present disclosure relates to aerosol generating apparatuses. A drawback with known aerosol generating apparatuses is that once the aerosol precursor is depleted, the heating element may overheat and/or exhibit an uncontrolled behaviour. Accordingly, there is provided a heating element (41) for an aerosol generating apparatus (1), comprising a conductive heating filament (40) configured to heat up a liquid precursor (6) to produce aerosol; and a temperature reactive element (42); wherein the temperature reactive (42) element is conductive up to a defined threshold temperature; wherein the temperature reactive element (42) is arranged to become non-conductive when exceeding the defined threshold temperature; and wherein the conductive heating filament (40) arranged in electrical series connection with the temperature reactive element (42).

### FIELD

The present disclosure relates to a heating element, a heating system and an aerosol generating apparatus.

### BACKGROUND

A typical aerosol generating apparatus may comprise a power supply, an aerosol generating unit that is driven by the power supply, an aerosol precursor, which in use is aerosolised by the aerosol generating unit to generate an aerosol, and a delivery system for delivery of the aerosol to a user.

A drawback with known aerosol generating apparatuses is that once the aerosol precursor is depleted, the heating element may overheat and/or exhibit an uncontrolled behaviour.

In spite of the effort already invested in the development of aerosol generating apparatuses/systems further improvements are desirable.

### SUMMARY

The present disclosure provides a heating element for an aerosol generating apparatus that comprises a heating filament configured to heat up a liquid precursor to produce aerosol.

In some examples, the heating element comprises a temperature reactive element, wherein the temperature reactive element is conductive up to a defined threshold temperature, wherein the temperature reactive element is arranged to become non-conductive when exceeding the defined threshold temperature and wherein the conductive heating filament arranged in electrical series connection with the heating filament.

The present disclosure further provides a heating system, comprising a heating element according to the present disclosure and a wick, wherein at least the heating filament is deposited onto the wick.

The present disclosure further provides a consumable for an aerosol generating apparatus, comprising a heating element and/or a heating system according to at least one the preceding claims.

The present disclosure further provides a set of an aerosol generating apparatus and a consumable according to at least one of the preceding claims.

In an aerosol generating apparatus, a precursor material, in particular a liquid precursor material is heated by a heater so to aerosolize the precursor material for inhalation. A heater regularly comprises a resistive, conductive element that is powered by a power source so that its temperature increases. The precursor material is brought into contact with the heater, thereby increasing its temperature to a point where the precursor material is aerosolized. While the heater provides energy to the precursor material, the precursor material in turn provides a cooling effect on the heater by being aerosolized. In other words, a heater that is in contact with precursor material has a lower temperature than the same heater, powered by the same amount of energy without the contact with precursor material. In case there is no contact with precursor material, the heater would regularly be in contact with air, which provides a reduced cooling effect. A heater in contact with precursor material thus exhibits a lower temperature than a heater in contact with air alone.

The difference in temperature may be such that a temperature in excess of the nominal temperature when in contact with precursor material may be undesirable. For example, an aerosol generating apparatus may be designed for a certain heater temperature coinciding with the evaporation of precursor material. Further, an aerosol generating apparatus may not be specifically designed for a certain heater temperature occurring when no precursor material provides a cooling effect to the heater. It may thus be desirable to avoid a heater temperature occurring when no precursor material is available. In order to avoid such an increased heater temperature, it may be beneficial to detect the presence or absence of precursor material at the heater. In case the absence of precursor material is detected, the aerosol generating apparatus may control the heater in a way so to reduce the heater temperature. E.g., energy provided to the heater may be reduced or even be completely switched off.

Alternatively to controlling the heater in a way to reduce its temperature, a failsafe mechanism may be implemented to shut of power supplied to the heater altogether. Such a shut off may be an active shut off or, in accordance with the present disclosure may be a passive shut off. Passive shut off is a shut off where no active control of the shut of procedure is performed. As such, a passive shut off is less likely to fail since the shut off is not dependent on the functionality of further elements. Rather, the shut off is initiated by an element that reacts itself when a threshold temperature is exceeded. A complete shut off of the energy supplied to the heater may e.g., be the interruption of the electric circuit feeding the energy to the heater. Put another way, the electric circuit may be interrupted by opening the circuit at a defined point so that no current is able to flow through the heater anymore, thereby reducing power supplied to the heater to essentially zero.

The interruption may be performed by a temperature reactive element, which itself reacts to exceeding the threshold temperature. E.g., the temperature reactive element may have different electrical or physical properties below the threshold temperature and above the threshold temperature, which provides the interruption functionality. For example, the temperature reactive element may be a conductive element that disintegrates when the threshold temperature is exceeded. By its disintegration, the temperature reactive element may not be able to provide its conducting function anymore, thereby interrupting the electric circuit. In order to be able to reliably interrupt the electric circuit, the temperature reactive element may be arranged in series to other elements of the electric circuit, e.g., the electric heating circuit, so to assure that all current flows through the temperature reactive element. This assures that power supplied to the heater element is reliably interrupted by disintegration of the temperature reactive element, as no parallel path for the current is available.

When the threshold temperature is exceeded and thus the temperature reactive element disintegrates, such may also be understood as a “burning up” of the temperature reactive element, so that it loses is physical form as a conductor, e.g., by melting. Likewise, in case the temperature reactive element is a material used for connecting elements of the electric circuit, e.g., soldering the heating element to a PCB or the like, the disintegration may be the melting of the solder resulting in an interruption of the circuit. In addition to the melting of the solder, the elements being soldered together may move apart or move relative to one another thereby producing a gap between the soldered elements and thereby interrupting the electric circuit.

The temperature reactive element may be a section or part of the heating filament, e.g., having a diameter less than 1 mm and may be embodied as a thin tunnel in the heating element. The temperature reactive element may be a serial element, e.g., a fuse wire, made of low melting point alloy, between the heating filament and a connector of the heating filament or between two sections of the heating filament. It will disconnect when the temperature rises high enough to melt the alloy. Alternatively, the temperature reactive element may be implemented by using a low melting point alloy powder for soldering or as part of the solder. When the temperature rises high enough, it will melt and disconnect. When there is little or no liquid precursor, the temperature of the heating element will increase as there is no cooling effect from the precursor material. When the temperature rises too high, the temperature reactive element disconnects the electric conductive connection, thereby preventing energy being provided to the heating element, so that the heating element is prevented from operating when it is at a high temperature.

Since the temperature reactive element is exposed to different temperatures dependent on the location of the temperature reactive element relative to the heating filament, the location of the temperature reactive element may be employed to adjust the melt down threshold or melt down temperature. E.g., provisioning the temperature reactive element near the heating filament or adjacent to the wick may be employed to open the electrical connection at a defined temperature, which may be different for the placement near the heating filament and the wick.

When the heating filament is provisioned by printing on the wick, the temperature reactive element may be likewise provisioned by printing, e.g., in a single printing procedure, where the width/size of the heating filament and the temperature reactive element are varied, so that the temperature reactive element will have less material and thus melts at a lower temperature than the heating filament would. The temperature reactive element may be an alloy, e.g., a tin alloy or any other safety alloy like e.g., a zinc alloy, with a melting point of about 200-300 °C. For example, the melting temperature may me e.g., substantially 275 °C, and the alloy may comprise tin, copper, silver or other metals or a mixture thereof. By changing the percentages of metals and/or materials, the melting temperature of the alloy may be set to the desired melting temperature.

A wick may comprise an opening socket or through-hole which fits the heating filament and the temperature reactive element under the ceramic. In one example, after the ceramic wick is sintered the combination of heating filament and the temperature reactive element is provided in the opening socket or through-hole. Alternatively, it is conceivable to print the heating filament or otherwise install it on the outside of the wick and subsequently change the heater filament material to generate the regain of the temperature reactive element. E.g., part of the material of the heating filament may be removed after provisioning, e.g., printing or otherwise deposition, for example by etching or abrasing, so to obtain a region of the heating filament which is the temperature reactive element. As such, the temperature reactive element may be an integral part of the heating filament, i.e., the temperature reactive element may be a part of the heating filament.

Melting of the temperature reactive element results in a non-reusable heating element, wick or generally consumable. This may provide the advantage to avoid possibly dangerous refilling of the consumable.

The precursor material may provide a cooling effect of the vapour, which may be required to place the temperature reactive element proximate the heating filament, while avoiding an early melting.

In some examples, the heating filament may comprise at least two heating filament sections and the temperature reactive element may be arranged in electrical series connection in between the at least two heating filament sections.

In this way, the temperature reactive element may be arranged symmetrically with regard to a heat source, i.e., the two heating filament sections, so that the temperature reactive element is exposed to the heat generated by both heating filament sections, thereby being heated more uniformly. This on the one hand may provide a reliable interruption of the electric circuit once the threshold temperature has been exceeded and on the one hand may avoid a premature interruption due to localized overheating of the temperature reactive element, in case it is only heated from one side. Alternatively, if the temperature reactive element is only heated from one side, it may not receive sufficient heat energy to reliably disintegrate and thus interrupted the electric circuit.

In some examples, the heating element may comprise at least one connector for connecting the heating filament to an external energy source and temperature reactive element may be connecting the at least one connector to the heating element.

In this way, the temperature reactive element may be a starter connecting the heating filament or a part of the heating element to the connector. Once the threshold temperature is exceeded and the temperature reactive element disintegrated and thus has become known conductive, a solder connection between the heating element and the connector may be removed. By removing the solder connection, the electric circuit is interrupted. The same time, a particular force may act on at least one of the heating element and the connector so that when the force fit connection provided by the temperature reactive element embodied as a solder is removed due to the melting of the temperature reactive element, the heating element and the connector may distance from one another, e.g., by generating a non-conductive, thereby interrupting the electric circuit.

In some examples, the temperature reactive element may comprise a meltable material and the meltable material may be arranged to melt when the defined threshold temperature is exceeded, thereby interrupting the electrical series connection of the conductive heating filament and the heating filament.

In this way, the temperature reactive element may reliably interrupt the electric circuit, as it may be assumed that once the threshold temperature has been exceeded and thus the previously solid temperature reactive element has melted, the previous shape has been deformed to such an extent that even if the temperature goes below the threshold temperature again, and the temperature reactive element would really solidify, the conductive connection is not re-established again.

In some examples, the temperature reactive element may be one of a low melting point material, low melting point alloy, a low melting point solder, a tin alloy, a zinc alloy, a material with a melting point between 200 and 300 °C, a material with a melting point between 250 and 300 °C, a material with a melting point between 270 and 290 °C, a material with a melting point at ca. 275 °C

In this way, the temperature reactive element may interrupt the electric circuit at a temperature that is well above the normal use temperature when applied in an aerosol generating apparatus but low enough to quickly interrupt the electric circuit once the normal use temperature or the threshold temperature is exceeded.

In some examples, the heating filament and the temperature reactive element may be integrally formed. In this way, a heat transfer from the heating filament to the temperature reactive element may be provided in a preferred manner. As such, a part of the heating filament may function as the temperature reactive element. E.g., the part of the heating filament corresponding to the temperature reactive element may be embodied with different physical properties so that the interruption functionality may be provided. For example, the temperature reactive element may be thinner and thus may heat up more easily by a current going through the heating filament and the remainder of the heating filament. Alternatively or additionally, the section of the heating filament corresponding to the temperature reactive element may be shaped differently which may result in nonuniform temperature of the heating filament, i.e., a higher temperature in the section of the temperature reactive element when compared to the remainder of the heating element. E.g., the temperature reactive element may have a meander-like, curved or curled shape while the remaining heating element has a different shape so that the temperature reactive element heats up more than the other sections of the heating filament. It is further conceivable, that the temperature reactive element differs from the heating element both in a physical property and in shape.

In some examples, the wick may comprise a hollow section or a through hole and the temperature reactive element may be at least partly arranged in at least a part of the hollow section or the through hole.

In this way, the temperature reactive element may be more uniformly heated in the interior of the wick as it is surrounded by heated material of the wick then when mounted to the surface of the wick. It is also conceivable that the temperature reactive element is printed inside the ceramic body. Alternatively, a through hole may be formed in the ceramic body of the wick and the temperature reactive element may be inserted therein. Additionally, such may provide better sensitivity, i.e., a more reliable defined disintegration or becoming non-conductive of the temperature reactive element.

In some examples, the wick may have a first end surface and a second end surface arranged opposite of the first end surface, the heating filament may be arranged at the first end surface and the liquid precursor may be arriving at the wick in the region of the second end surface.

In this way, the liquid precursor may be heated more reliably by the wick, which in turn is heated by the heating element. E.g., the size or volume of the week may be larger than the heating filament, thereby distributing the heat and providing a larger surface for aerosolization of the liquid precursor. The same time, the heating filament is shielded from the liquid precursor, e.g., direct contact with the liquid precursor, since all aerosolization is conducted at the second end surface and thus on the opposite side of the wick than the heating filament.

In some examples, the temperature reactive element may be arranged at least partly in the interior of the wick in between the first end surface and the second end surface.

In this way, the temperature reactive element is shielded from the liquid precursor. In particular, the temperature reactive element may be seen as being shielded from a cooling effect that the liquid precursor would provide when being aerosolized. Such a cooling effect could counteract the becoming non-conductive of the temperature reactive element at the appropriate temperature since the temperature of the temperature reactive element is kept below the threshold temperature due to the cooling effect of the liquid precursor aerosolization.

In some examples, the consumable may comprise a retention element arranged to retain at least a part of the temperature reactive element having become non-conductive, so to prevent exposure of a user to the temperature reactive element.

In some examples, the retention element may be a sponge-like element arranged to retain a liquified or melted part of the temperature reactive element.

In this way, a user of the aerosol generating apparatus may be shielded from a liquefied or melted material of the temperature reactive element, as it is stored in the retention element immediately after disintegration. Otherwise, at least part of the disintegrated temperature reactive element to arrive in the mouth of the user, resulting in an undesirable smoking experience.

A spongelike element may receive the liquefied or melted temperature reactive element material thereby retaining the material within the spongelike element and thereby preventing exposure of a user to temperature reactive element material.

The preceding summary is provided for purposes of summarizing some examples to provide a basic understanding of aspects of the subject matter described herein. Accordingly, the above-described features should not be construed to narrow the scope or spirit of the subject matter described herein in any way. Moreover, the above and/or proceeding examples may be combined in any suitable combination to provide further examples, except where such a combination is clearly impermissible or expressly avoided. Other features, aspects, and advantages of the subject matter described herein will become apparent from the following text and the accompanying drawings.

### BRIEF DESCRIPTION OF THE FIGURES

Aspects, features and advantages of the present disclosure will become apparent from the following description of examples in reference to the appended drawings in which like numerals denote like elements.

FIG. 1 is a block system diagram showing an example aerosol generating apparatus.

FIG. 2 is a block system diagram showing an example implementation of the apparatus of FIG. 1, where the aerosol generating apparatus is configured to generate aerosol from a liquid precursor.

FIGS. 3a and 3b are schematic diagrams showing an example implementation of the apparatus of FIG. 2.

FIG. 4a,b show a first exemplary heating element according to the present disclosure.

FIG. 5 show a second exemplary heating element according to the present disclosure.

FIG. 6 show a third exemplary heating element according to the present disclosure.

### DETAILED DESCRIPTION OF EMBODIMENTS

Before describing several examples implementing the present disclosure, it is to be understood that the present disclosure is not limited by specific construction details or process steps set forth in the following description and accompanying drawings. Rather, it will be apparent to those skilled in the art having the benefit of the present disclosure that the systems, apparatuses and/or methods described herein could be embodied differently and/or be practiced or carried out in various alternative ways.

Unless otherwise defined herein, scientific and technical terms used in connection with the presently disclosed inventive concept(s) shall have the meanings that are commonly understood by those of ordinary skill in the art, and known techniques and procedures may be performed according to conventional methods well known in the art and as described in various general and more specific references that may be cited and discussed in the present specification.

Any patents, published patent applications, and non-patent publications mentioned in the specification are hereby incorporated by reference in their entirety.

All examples implementing the present disclosure can be made and executed without undue experimentation in light of the present disclosure. While particular examples have been described, it will be apparent to those of skill in the art that variations may be applied to the systems, apparatus, and/or methods and in the steps or in the sequence of steps of the methods described herein without departing from the concept, spirit, and scope of the inventive concept(s). All such similar substitutions and modifications apparent to those skilled in the art are deemed to be within the spirit, scope, and concept of the inventive concept(s) as defined by the appended claims.

The use of the term “a” or “an” in the claims and/or the specification may mean “one,” as well as “one or more,” “at least one,” and “one or more than one.” As such, the terms “a,” “an,” and “the,” as well as all singular terms, include plural referents unless the context clearly indicates otherwise. Likewise, plural terms shall include the singular unless otherwise required by context.

The use of the term “or” in the present disclosure (including the claims) is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used in this specification and claim(s), the words “comprising, “having,” “including,” or “containing” (and any forms thereof, such as “comprise” and “comprises,” “have” and “has,” “includes” and “include,” or “contains” and “contain,” respectively) are inclusive or open-ended and do not exclude additional, unrecited elements or method steps.

Unless otherwise explicitly stated as incompatible, or the physics or otherwise of the embodiments, examples, or claims prevent such a combination, the features of examples disclosed herein, and of the claims, may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g., numbering) of example(s), embodiment(s), or dependency of claim(s). Moreover, this also applies to the phrase “in one embodiment,” “according to an embodiment,” and the like, which are merely a stylistic form of wording and are not to be construed as limiting the following features to a separate embodiment to all other instances of the same or similar wording. This is to say, a reference to ‘an,’ ‘one,’ or ‘some’ embodiment(s) may be a reference to any one or more, and/or all embodiments, or combination(s) thereof, disclosed. Also, similarly, the reference to “the” embodiment may not be limited to the immediately preceding embodiment. Further, all references to one or more embodiments or examples are to be construed as non-limiting to the claims.

The present disclosure may be better understood in view of the following explanations, wherein the terms used that are separated by “or” may be used interchangeably:

As used herein, an “aerosol generating apparatus” (or “electronic(e)-cigarette”) may be an apparatus configured to deliver an aerosol to a user for inhalation by the user. The apparatus may additionally/alternatively be referred to as a “smoking substitute apparatus”, if it is intended to be used instead of a conventional combustible smoking article. As used herein a combustible “smoking article” may refer to a cigarette, cigar, pipe or other article, that produces smoke (an aerosol comprising solid particulates and gas) via heating above the thermal decomposition temperature (typically by combustion and/or pyrolysis). An aerosol generated by the apparatus may comprise an aerosol with particle sizes of 0.2-7 microns, or less than 10 microns, or less than 7 microns. This particle size may be achieved by control of one or more of: heater temperature; cooling rate as the vapour condenses to an aerosol; flow properties including turbulence and velocity. The generation of aerosol by the aerosol generating apparatus may be controlled by an input device. The input device may be configured to be user-activated, and may for example include or take the form of an actuator (e.g., actuation button) and/or an airflow sensor.

Each occurrence of the aerosol generating apparatus being caused to generate aerosol for a period of time (which may be variable) may be referred to as an “activation” of the aerosol generating apparatus. The aerosol generating apparatus may be arranged to allow an amount of aerosol delivered to a user to be varied per activation (as opposed to delivering a fixed dose of aerosol), e.g., by activating an aerosol generating unit of the apparatus for a variable amount of time, e.g., based on the strength/duration of a draw of a user through a flow path of the apparatus (to replicate an effect of smoking a conventional combustible smoking article).

The aerosol generating apparatus may be portable. As used herein, the term “portable” may refer to the apparatus being for use when held by a user.

As used herein, an “aerosol generating system” may be a system that includes an aerosol generating apparatus and optionally other circuitry/components associated with the function of the apparatus, e.g., one or more external devices and/or one or more external components (here “external” is intended to mean external to the aerosol generating apparatus).

As used herein, an “external device” and “external component” may include one or more of a: a charging device, a mobile device (which may be connected to the aerosol generating apparatus, e.g., via a wireless or wired connection); a networked-based computer (e.g., a remote server); a cloud-based computer; any other server system.

An example aerosol generating system may be a system for managing an aerosol generating apparatus. Such a system may include, for example, a mobile device, a network server, as well as the aerosol generating apparatus.

As used herein, an “aerosol” may include a suspension of precursor, including as one or more of: solid particles; liquid droplets; gas. Said suspension may be in a gas including air. An aerosol herein may generally refer to/include a vapour. An aerosol may include one or more components of the precursor.

As used herein, a “precursor” may include one or more of a: liquid; solid; gel; loose leaf material; other substance. The precursor may be processed by an aerosol generating unit of an aerosol generating apparatus to generate an aerosol. The precursor may include one or more of: an active component; a carrier; a flavouring. The active component may include one or more of nicotine; caffeine; a cannabidiol oil; a non-pharmaceutical formulation, e.g., a formulation which is not for treatment of a disease or physiological malfunction of the human body. The active component may be carried by the carrier, which may be a liquid, including propylene glycol and/or glycerine. The term “flavouring” may refer to a component that provides a taste and/or a smell to the user. The flavouring may include one or more of: Ethylvanillin (vanilla); menthol, Isoamyl acetate (banana oil); or other. The precursor may include a substrate, e.g., reconstituted tobacco to carry one or more of the active component; a carrier; a flavouring.

As used herein, a “storage portion” may be a portion of the apparatus adapted to store the precursor. It may be implemented as fluid-holding reservoir or carrier for solid material depending on the implementation of the precursor as defined above.

As used herein, a “flow path” may refer to a path or enclosed passageway through an aerosol generating apparatus, e.g., for delivery of an aerosol to a user. The flow path may be arranged to receive aerosol from an aerosol generating unit. When referring to the flow path, upstream and downstream may be defined in respect of a direction of flow in the flow path, e.g., with an outlet being downstream of an inlet.

As used herein, a “delivery system” may be a system operative to deliver an aerosol to a user. The delivery system may include a mouthpiece and a flow path.

As used herein, a “flow” may refer to a flow in a flow path. A flow may include aerosol generated from the precursor. The flow may include air, which may be induced into the flow path via a puff by a user. As used herein, a “puff” (or “inhale” or “draw”) by a user may refer to expansion of lungs and/or oral cavity of a user to create a pressure reduction that induces flow through the flow path.

As used herein, an “aerosol generating unit” may refer to a device configured to generate an aerosol from a precursor. The aerosol generating unit may include a unit to generate a vapour directly from the precursor (e.g., a heating system or other system) or an aerosol directly from the precursor (e.g., an atomiser including an ultrasonic system, a flow expansion system operative to carry droplets of the precursor in the flow without using electrical energy or other system). A plurality of aerosol generating units to generate a plurality of aerosols (for example, from a plurality of different aerosol precursors) may be present in an aerosol generating apparatus.

As used herein, a “heating system” may refer to an arrangement of at least one heating element, which is operable to aerosolise a precursor once heated. The at least one heating element may be electrically resistive to produce heat from the flow of electrical current therethrough. The at least one heating element may be arranged as a susceptor to produce heat when penetrated by an alternating magnetic field. The heating system may be configured to heat a precursor to below 300 or 350 degrees C, including without combustion.

As used herein, a “consumable” may refer to a unit that includes a precursor. The consumable may include an aerosol generating unit, e.g., it may be arranged as a cartomizer. The consumable may include a mouthpiece. The consumable may include an information carrying medium. With liquid or gel implementations of the precursor, e.g., an e-liquid, the consumable may be referred to as a “capsule” or a “pod” or an “e-liquid consumable”. The capsule/pod may include a storage portion, e.g., a reservoir or tank, for storage of the precursor. With solid material implementations of the precursor, e.g., tobacco or reconstituted tobacco formulation, the consumable may be referred to as a “stick” or “package” or “heat-not-burn consumable”. In a heat-not-burn consumable, the mouthpiece may be implemented as a filter and the consumable may be arranged to carry the precursor. The consumable may be implemented as a dosage or pre-portioned amount of material, including a loose-leaf product.

As used herein, an “information carrying medium” may include one or more arrangements for storage of information on any suitable medium. Examples include: a computer readable medium; a Radio Frequency Identification (RFID) transponder; codes encoding information, such as optical (e.g., a bar code or QR code) or mechanically read codes (e.g., a configuration of the absence or presents of cut-outs to encode a bit, through which pins or a reader may be inserted).

As used herein “heat-not-burn” (or “HNB” or “heated precursor”) may refer to the heating of a precursor, typically tobacco, without combustion, or without substantial combustion (i.e., localised combustion may be experienced of limited portions of the precursor, including of less than 5% of the total volume).

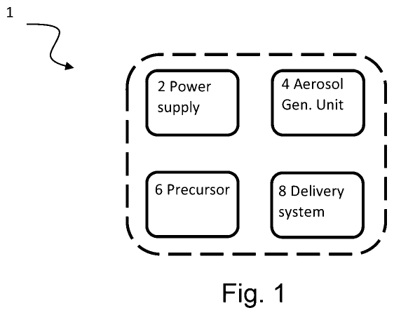

Referring to FIG. 1, an example aerosol generating apparatus 1 includes a power supply 2, for supply of electrical energy. The apparatus 1 includes an aerosol generating unit 4 that is driven by the power supply 2. The power supply 2 may include an electric power supply in the form of a battery and/or an electrical connection to an external power source. The apparatus 1 includes a precursor 6, which in use is aerosolised by the aerosol generating unit 4 to generate an aerosol. The apparatus 2 includes a delivery system 8 for delivery of the aerosol to a user.

Electrical circuitry (not shown in FIG. 1) may be implemented to control the interoperability of the power supply 4 and aerosol generating unit 6.

In variant examples, which are not illustrated, the power supply 2 may be omitted since, e.g., an aerosol generating unit implemented as an atomiser with flow expansion may not require a power supply.

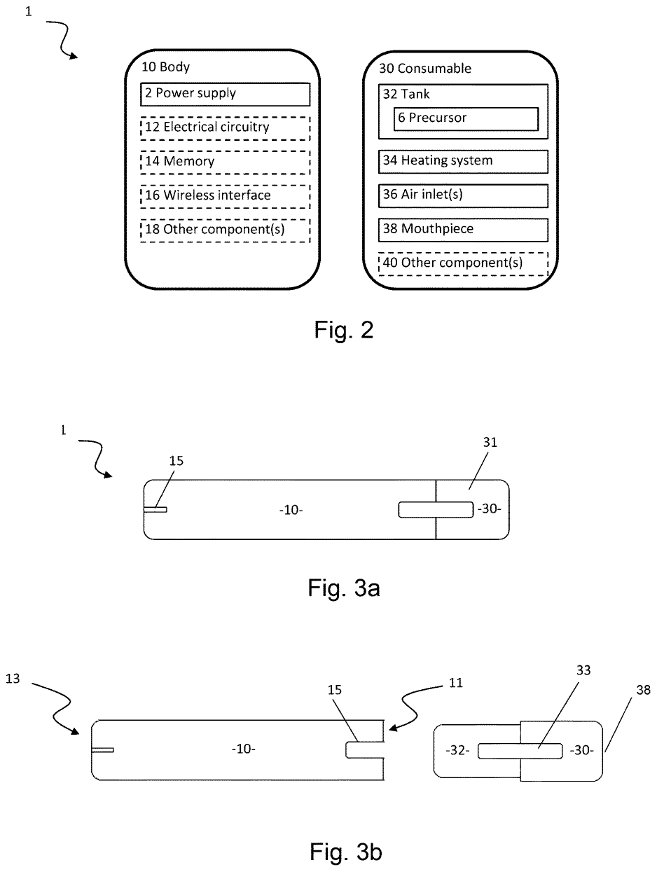

FIG. 2 shows an implementation of the apparatus 1 of FIG. 1, where the aerosol generating apparatus 1 is configured to generate aerosol from a liquid precursor.

In this example, the apparatus 1 includes a device body 10 and a consumable 30.

In this example, the body 10 includes the power supply 4. The body may additionally include any one or more of electrical circuitry 12, a memory 14, a wireless interface 16, one or more other components 18.

The electrical circuitry 12 may include a processing resource for controlling one or more operations of the body 10 and consumable 30, e.g., based on instructions stored in the memory 14.

The wireless interface 16 may be configured to communicate wirelessly with an external (e.g., mobile) device, e.g., via Bluetooth.

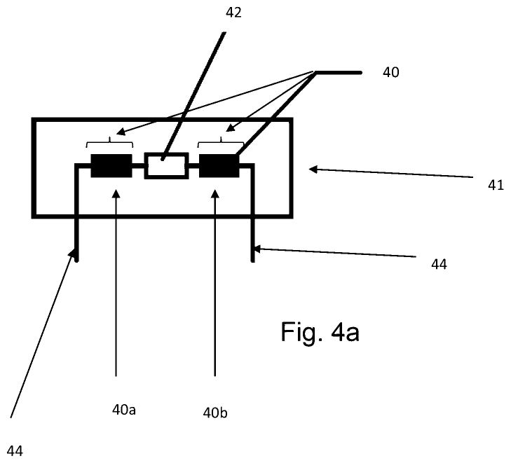

The other component(s) 18 may include one or more user interface devices configured to convey information to a user and/or a charging port, for example (see e.g., FIG. 3).

The consumable 30 includes a storage portion implemented here as a tank 32 which stores the liquid precursor 6 (e.g., e-liquid). The consumable 30 also includes a heating system 34, one or more air inlets 36, and a mouthpiece 38. The consumable 30 may include one or more other components 40.

The body 10 and consumable 30 may each include a respective electrical interface (not shown) to provide an electrical connection between one or more components of the body 10 with one or more components of the consumable 30. In this way, electrical power can be supplied to components (e.g., the heating system 34) of the consumable 30, without the consumable 30 needing to have its own power supply.

In use, a user may activate the aerosol generating apparatus 1 when inhaling through the mouthpiece 38, i.e., when performing a puff. The puff, performed by the user, may initiate a flow through a flow path in the consumable 30 which extends from the air inlet(s) 34 to the mouthpiece 38 via a region in proximity to the heating system 34.

Activation of the aerosol generating apparatus 1 may be initiated, for example, by an airflow sensor in the body 10 which detects airflow in the aerosol generating apparatus 1 (e.g., caused by a user inhaling through the mouthpiece), or by actuation of an actuator included in the body 10. Upon activation, the electrical circuitry 12 (e.g., under control of the processing resource) may supply electrical energy from the power supply 2 to the heating system 34 which may cause the heating system 34 to heat liquid precursor 6 drawn from the tank to produce an aerosol which is carried by the flow out of the mouthpiece 38.

In some examples, the heating system 34 may include a heating filament and a wick, wherein a first portion of the wick extends into the tank 32 in order to draw liquid precursor 6 out from the tank 32, wherein the heating filament coils around a second portion of the wick located outside the tank 32. The heating filament may be configured to heat up liquid precursor 6 drawn out of the tank 32 by the wick to produce the aerosol.

In this example, the aerosol generating unit 4 is provided by the above-described heating system 34 and the delivery system 8 is provided by the above-described flow path and mouthpiece 38.

In variant embodiments (not shown), any one or more of the precursor 6, heating system 34, air inlet(s) 36 and mouthpiece 38, may be included in the body 10. For example, the mouthpiece 36 may be included in the body 10 with the precursor 6 and heating system 34 arranged as a separable cartomizer. FIGS. 3a and 3b show an example implementation of the aerosol generating device 1 of FIG. 2. In this example, the consumable 30 is implemented as a capsule/pod, which is shown in FIG. 3a as being physically coupled to the body 10, and is shown in FIG. 3b as being decoupled from the body 10.

In this example, the body 10 and the consumable 30 are configured to be physically coupled together by pushing the consumable 30 into an aperture in a top end 11 the body 10, with the consumable 30 being retained in the aperture via an interference fit.

In other examples (not shown), the body 10 and the consumable 30 could be physically coupled together in other ways, e.g., by screwing one onto the other, through a bayonet fitting, or through a snap engagement mechanism, for example.

The body 10 also includes a charging port (not shown) at a bottom end 13 of the body 10.

The body 10 also includes a user interface device configured to convey information to a user. Here, the user interface device is implemented as a light 15, which may e.g., be configured to illuminate when the apparatus 1 is activated. Other user interface devices are possible, e.g., to convey information haptically or audibly to a user.

In this example, the consumable 30 has an opaque cap 31, a translucent tank 32 and a translucent window 33. When the consumable 30 is physically coupled to the body 10 as shown in FIG. 3a, only the cap 31 and window 33 can be seen, with the tank 32 being obscured from view by the body 10. The body 10 includes a slot 15 to accommodate the window 33. The window 33 is configured to allow the amount of liquid precursor 6 in the tank 32 to be visually assessed, even when the consumable 30 is physically coupled to the body 10.

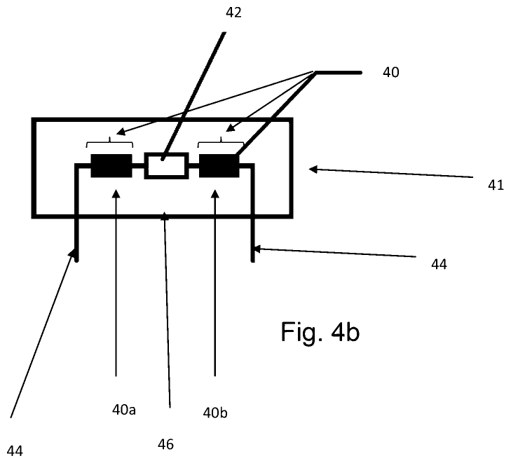

FIG. 4a,b show a first exemplary heating element according to the present disclosure, which may be implemented in any of the preceding examples.

FIG. 4a shows a heating element 41 comprising a heating filament 40 and a temperature reactive element 42. In the exemplary embodiment of FIG. 4a, the heating filament 40 comprises two separate heating filament sections 40a,b, between which the temperature reactive element 42 is arranged. The heating filament sections 40a,b and the temperature reactive element 42 are arranged in series connection. The heating element 41 and thus the two sides of the series chain of heating filament sections 44a,b and temperature reactive element 42 are connected to the outside of the heating element 41 by connectors 44. Power may be supplied to the heating filament 40 and the temperature reactive element 42 by applying a voltage across the connectors 44. Applying said voltage results in a current flowing in through one connector 44, through the series connection of heating filament section 40a, temperature reactive element 42 and heating filament section 40b and out through the other connector 44.

Current can only flow through said series connection in case all elements, the heating filament sections 40a,b and the temperature reactive element 42, are in a conductive state and conductively connected. In case one of the elements of the series connection becomes non-conductive, e.g., by disintegration, melting or the like, the series connection is interrupted and no current can flow from one connector through the series connection to the other connector.

The temperature reactive element 42a is exemplarily arranged in between the two heating filament sections 40a,b. That way, the temperature reactive element 42 is evenly heated by the heating filament sections from both sides. This allows that the temperature reactive element 42 assumes an essentially uniform temperature corresponding to the actual temperature of the heating filament. Once the temperature the temperature reactive element 42 is exposed to exceeds a certain threshold value, the temperature reactive element 42 is arranged to become non-conductive. This may be realized by dimensioning the temperature reactive element 42 in a way so that its structural integrity disintegrates, e.g., its material melts or evaporates. That way, the conductive connection between the heating filament sections 40a and 40b opens and the heating element 41 becomes non-conductive. Now, no energy may be applied to the heating element 41 anymore since no current can flow through the heating element 41. Alternatively, the temperature reactive element 42 may exhibit a different physical parameter that allows the becoming non-conductive to be realized.

FIG. 4B essentially depicts the same embodiment as FIG. 4A, however additionally, a retention element 46 is provided, in the area of, in the vicinity of or adjacent to the temperature reactive element 42. The retention element 46 may be designed to receive disintegrated material of the temperature reactive element 42. E.g., a melted or evaporated material of the temperature reactive element 42 is received and retained within the retention element 46 so that a user of an aerosol generating device is not exposed to the disintegrated material of temperature reactive element 42. Preferably, the retention element 46 is arranged downward of the temperature reactive element 42 in a gravity direction when considering the usual use position of an aerosol generating apparatus. That way, e.g., melted material of the temperature reactive 42 follows the gravity direction towards the retention element 46 and is received by and retained in the retention element 46.

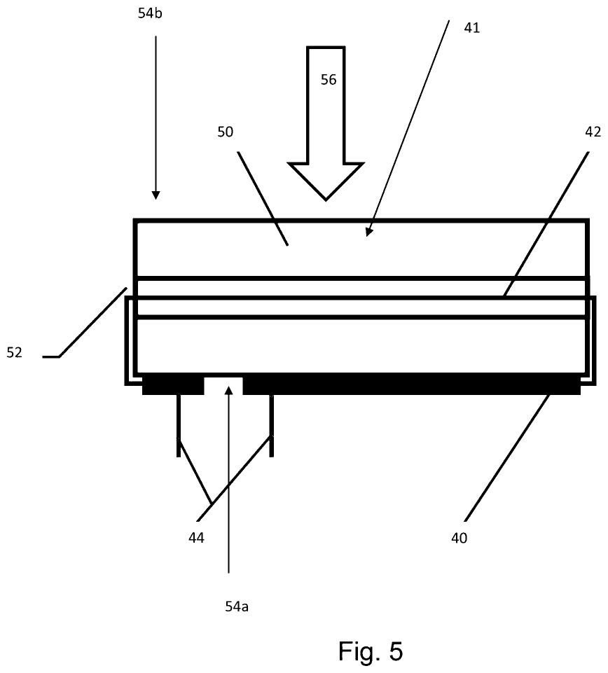

FIG. 5 show a second exemplary heating element according to the present disclosure, which may be implemented in any of the preceding examples.

FIG. 5 shows a heating element 41 comprising a heating filament 40 having two heating filament sections, which are connected by temperature reactive element 42. The heating element 41 further comprises a wick 50, to which the heating filament 40 is attached to at a first end surface 54a. The wick 50 comprises a through hole 52, in FIG. 5 exemplarily centrally arranged in the wick 50. The through hole 52 accommodates the temperature reactive element 42. In other words, the temperature element 42 is connecting to one heating filament section and goes through the through hole 52 and connects to the second heating filament section. A substantial part of the temperature reactive element 42 is thus arranged in the interior of wick 50. It is also conceivable that the whole temperature reactive element is arranged in the interior of the wick, in other words completely within the wick 50. A precursor material arrives 56 at a second end surface 54b of the wick, as depicted by arrow 56. Thus, the wick 50 is heated from the first end surface 54a towards the second end surface 54b.

When energy is provided to the heating element 41, in particular to heating filament 40, a voltage is provided across connectors 44 resulting in a current flowing through the series connection of the two heating filament sections of heating filament 40 and the temperature reactive element 42. In the embodiment of FIG. 5, the temperature reactive element 42 is thus arranged between the heating side of the wick, the first end surface 54a heated by heating filament 40, and the second end surface 54b receiving the precursor material to be liquefied. The arriving precursor material provides a cooling effect on the wick 50, thereby reducing the overall temperature of the wick 50, in particular the second end surface 54b, which progresses through the wick 50 towards the temperature reactive element 42 and to the heating filament 40 at the first end surface 54a. In other words, the temperature at the temperature reactive element 42 is thus a function of the temperature of the first end surface 54a heated by the heating filament 40 and the second end surface 54b cooled by the arriving precursor material 56.

In case less or no precursor material is arriving 56 at the second end surface 54b, the temperature of the second end surface 54b will raise above the temperature with arriving precursor material so that a temperature gradient between the second end surface 54b and the first end surface 54a is reduced (due to the lack of cooling by the precursor material), which results in a raising of the temperature at the position of the temperature reactive element 42 within wick 50. When the temperature at the temperature reactive element 42 raises above a defined threshold temperature, due to lack of cooling from arriving 56 precursor material, the temperature reactive element 42 can be arranged to become non-conductive, e.g., by disintegration, i.e., melting or evaporating of its material. Thereby, the conductive connection between the connectors through the heating filament sections and the temperature reactive element is interrupted so that no power may be provided to the heating element 41 anymore. This results in a passive stopping of the heating, i.e., since no control of provided energy or other parameters is required and the power feed is simply interrupted by the temperature reactive element 42 becoming non-conductive.

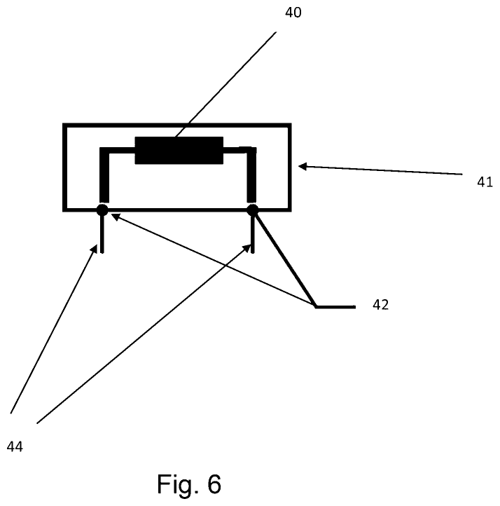

FIG. 6 show a third exemplary heating element according to the present disclosure, which may be implemented in any of the preceding examples.

In FIG. 6, exemplarily a single heating filament 40 of the heating element 41 is depicted. The heating filament 40 is connected to connectors 44 by exemplarily two temperature reactive elements 42. However, it may likewise be conceivable that only one of the two depicted temperature reactive elements 42 is implemented. The temperature reactive element 42 conductively connect the heating filament 40 with the connectors 44, in order to establish the conductive connection from one connector 44 to the other connected 44. The temperature reactive element 42 may be embodied as a solder connection between a connector and the heating filament 40. The melting temperature of the solder may be set so that when a defined threshold temperature is exceeded, the solder melts and thus interrupts the conductive connection between the connector and the heating filament 40. Thereby, when the temperature reactive element 42 becomes non-conductive, e.g., by melting of the solder, energy cannot be provided to the heating filament 40 anymore and the heating element 41 stops operating, i.e., stops heating.

1. A heating system for an aerosol generating apparatus, comprising:
a heating element; and
a wick,
wherein the heating element comprises:
a conductive heating filament configured to heat up a liquid precursor to produce aerosol; and
a temperature reactive element;
wherein at least the conductive heating filament is deposited onto the wick;
wherein the temperature reactive element is conductive up to a defined threshold temperature;
wherein the temperature reactive element is arranged to become non-conductive when exceeding the defined threshold temperature;
wherein the conductive heating filament is arranged in electrical series connection with the temperature reactive element:
wherein the wick comprises a through hole; and
wherein the temperature reactive element is at least partly arranged in at least a part of the through hole.

2. The heating system according to the preceding claim,
wherein the heating filament comprises at least two heating filament sections; and
wherein the temperature reactive element is arranged in electrical series connection in between the at least two heating filament sections.

3. The heating system according to claim 1,
wherein the heating element comprises at least one connector for connecting the heating filament to an external energy source; and
wherein the temperature reactive element is connecting the at least one connector to the heating element.

4. The heating system according to claim 1,
wherein the temperature reactive element comprises a meltable material; and
wherein the meltable material is arranged to melt when the defined threshold temperature is exceeded, thereby interrupting the electrical series connection of the temperature reactive element and the conductive heating filament.

5. The heating system according to claim 1, wherein the temperature reactive element is one of a low melting point material, low melting point alloy, a low melting point solder, a tin alloy, a zinc alloy, a material with a melting point between 200 and 300 °C, a material with a melting point between 250 and 300 °C, a material with a melting point between 270 and 290 °°C, a material with a melting point at ca. 275 °C.

6. The heating system according to claim 1, wherein the heating filament and the temperature reactive element are integrally formed.

7. (canceled)

8. The heating system according to claim 1, wherein the temperature reactive element is deposited onto the wick.

9. (canceled)

10. The heating system according to claim 1,
wherein the wick has a first end surface and a second end surface arranged opposite of the first end surface;
wherein the heating filament is arranged at the first end surface; and
wherein the liquid precursor is arriving at the wick in the region of the second end surface.

11. The heating system according to claim 1, wherein the temperature reactive element is arranged at least partly in the interior of the wick in between the first end surface and the second end surface.

12. A consumable for an aerosol generating apparatus, comprising a heating system according to claim 1.

13. The consumable according to the preceding claim, comprising a retention element arranged to retain at least a part of the temperature reactive element having become non-conductive, so as to prevent exposure of a user to the temperature reactive element.

14. The consumable according to the preceding claim, wherein the retention element is a sponge-like element arranged to retain a liquified or melted part of the temperature reactive element.

15. A set of an aerosol generating apparatus and the consumable according to claim 12.
